(19) United States
(12) Patent Application Publication
(10) Pub. No.: US 2026/0130340 A1
(43) Pub. Date: May 14, 2026

(54) Smart Automatic Pet Feeder with Refrigeration and Water Filtration

(71) Applicant: John Paul Yanes, Miami, FL (US)

(72) Inventor: John Paul Yanes, Miami, FL (US)

(21) Appl. No.: 18/942,509

(22) Filed: Nov. 9, 2024

(51) Int. Cl. A01K 5/02; A01K 7/02

(52) U.S. Cl. CPC A01K 5/0291; A01K 5/0225; A01K 5/0283; A01K 7/027; A01K 7/025

(57) ABSTRACT

An automatic pet feeding and watering apparatus is disclosed. The apparatus includes a housing containing a refrigerated food storage compartment and a separate refrigerated water reservoir. A thermoelectric cooling system is configured to cool both the food compartment and the water reservoir. The apparatus features a food delivery system with a direct chute for hygienically dispensing food into a bowl via gravity. It also includes a water delivery system that incorporates a filtration unit to ensure the delivery of clean, purified water. Certain embodiments may feature smart connectivity for remote control and monitoring via a mobile application. The combination of a unified refrigeration system for both fresh food and filtered water, along with a direct-chute food delivery mechanism, provides a comprehensive and hygienic solution for pet care.

Applicant respectfully submits the following Substitute Specification under 37 C.F.R. § 1.125. The specification has been amended to improve clarity, correct typographical errors, and provide express antecedent basis for the elements recited in the amended claims. The brief description of the drawings has been amended to incorporate descriptive matter originally present in the application as filed, and the detailed description has been revised accordingly.

NO NEW MATTER has been added, in compliance with 35 U.S.C. § 132(a). The submitted Substitute Specification replaces the previously filed specification in its entirety.

### BACKGROUND OF THE INVENTION

### Field of the Invention

The present invention relates to smart pet care devices, and more specifically, to an automatic pet feeder and water dispenser that incorporates refrigeration for both fresh food and water, along with a water filtration system.

### Description of Related Art

Existing automatic pet feeders are typically designed to dispense dry food, such as kibble. Many of these devices lack the capability to store and serve fresh or refrigerated food, which is a growing preference for many pet owners. Current feeders cannot maintain fresh or homemade meals at a safe temperature, leading to the risk of spoilage and contamination. While dry food is more shelf-stable, it can still be subject to contamination from moisture or improper cleaning of the feeder's components.

Similarly, automatic water dispensers often do not include filtration systems, which can result in pets drinking potentially unclean water. There is a growing need for a comprehensive solution that can refrigerate pet food, dispense cold, filtered water, and ensure that the apparatus itself remains hygienic and easy to maintain.

Previous inventions have focused on automating the timing and quantity of dry food dispensed, often using mechanical timers or basic electronic controls. However, these solutions fail to address the needs for fresh food preservation, water purity, and integrated smart technology for remote monitoring and control. They lack features such as temperature-controlled storage, integrated water filtration, and removable components that facilitate easy cleaning. Therefore, a need exists for an advanced and convenient solution for modern pet owners that combines these essential features into a single, comprehensive system.

### BRIEF SUMMARY OF THE INVENTION

The present invention addresses the shortcomings of the prior art by providing a new and improved automatic pet feeder. The primary objective is to provide an apparatus that offers a combination of refrigerated food storage, clean and filtered water dispensing, and multiple configurations to suit varying pet owner needs.

The invention is designed to accommodate both bulk dry food and fresh or refrigerated food. In certain embodiments, a thermoelectric cooling system maintains a proper temperature inside a food storage compartment, preventing spoilage and preserving the quality of fresh or homemade meals over extended periods. When storing dry food, this cooling function can be turned off.

A key feature of the invention is the integration of a refrigerated water delivery system that includes a filtration unit, such as an activated carbon filter, to ensure pets receive clean, cool, and filtered water.

Another key feature is a refrigerated food delivery system housed in its own compartment, which utilizes a direct, gravity-assisted food delivery pathway, or chute, to dispense food from a hopper directly into a feeding bowl. This design minimizes contact between the food and mechanical components, enhancing hygiene. The food storage compartment is removable and washable to ensure easy cleaning and maintenance.

The invention may be configured as a combined food and water unit or as a standalone water-only unit or food-only unit. Certain models are equipped with smart connectivity, allowing pet owners to control and monitor feeding schedules, portion sizes, and water levels remotely through a mobile application or smart home systems. Value-priced models may offer manual programming through onboard controls.

All models incorporate tamper-resistant mechanisms, such as secure locking lids, to prevent pets from accessing food or water outside of scheduled times. The feeder is constructed from durable, food-safe materials like ABS plastic, stainless steel, and food-grade silicone to ensure longevity and hygiene.

### BRIEF DESCRIPTION OF THE DRAWINGS

FIG. 1a is a front perspective view of the automatic pet feeding and watering apparatus in a combined food and water configuration, illustrating the housing, base member, recessed tray area, food bowl, and water bowl.

FIG. 1b is an exploded front perspective view of the automatic pet feeding and watering apparatus of FIG. 1a, showing the internal food storage compartment, water reservoir, food delivery system with chute and dispensing mechanism, and water delivery pathway.

FIG. 2a is a rear perspective view of the automatic pet feeding and watering apparatus of FIG. 1a, highlighting the cooling fan, vent slots, power input port, and rear panel.

FIG. 2b is a rear perspective view with a transparent cutaway of the automatic pet feeding and watering apparatus of FIG. 1a, revealing the thermoelectric cooling system with cooling fins and coils.

FIG. 2c is another rear perspective view with a transparent cutaway of the automatic pet feeding and watering apparatus of FIG. 1a, illustrating the internal position of the cooling fan within the cooling system.

FIG. 3 is a cross-sectional front perspective view of the automatic pet feeding and watering apparatus, showing the food storage compartment, bulk food hopper, chute, food dispensing control mechanism, water reservoir, and water delivery pathway leading to the respective bowls.

FIG. 4 is an elevation view of the automatic pet feeding and watering apparatus, depicting the food and water delivery systems, including the water filtration unit within the water reservoir.

### DETAILED DESCRIPTION OF THE INVENTION

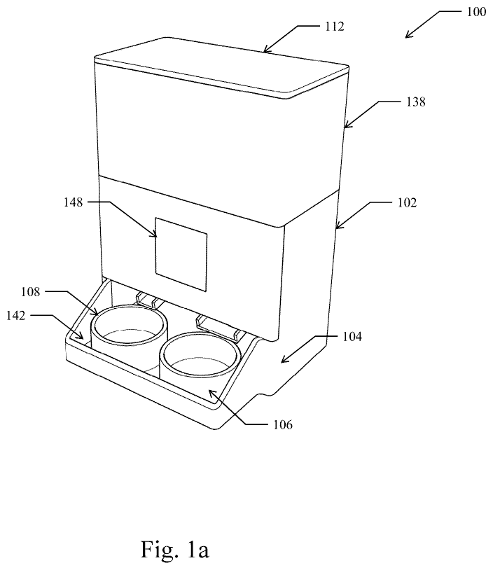

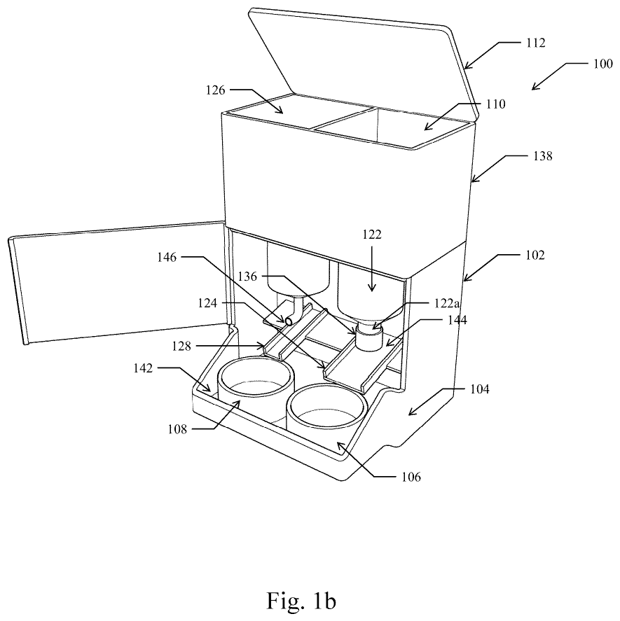

Referring now to the drawings, FIGS. 1a-1b show front perspective views of the automatic pet feeder and watering apparatus 100 in a combined food and water configuration. The apparatus 100 comprises a housing 102 which supports a food delivery system 144 and a water delivery system 146 that dispenses clean, filtered water. The housing 102 may be constructed from a durable, food-safe material such as ABS plastic. The housing defines a base member 104 that provides stability to the apparatus and includes a recessed tray area 142 to accommodate a food bowl 106 and a water bowl 108. The food bowl 106 and the water bowl 108 are both removable to facilitate easy cleaning.

An upper section 138 of the housing 102 contains a food storage compartment 110 and a water reservoir 126, which are accessible for refilling through a secure, tamper-resistant door 112.

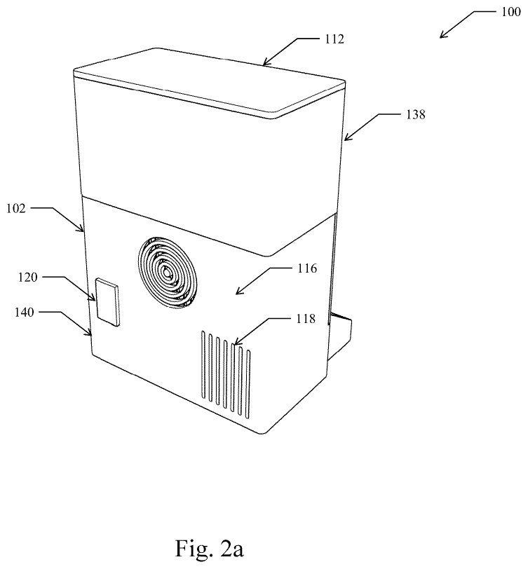

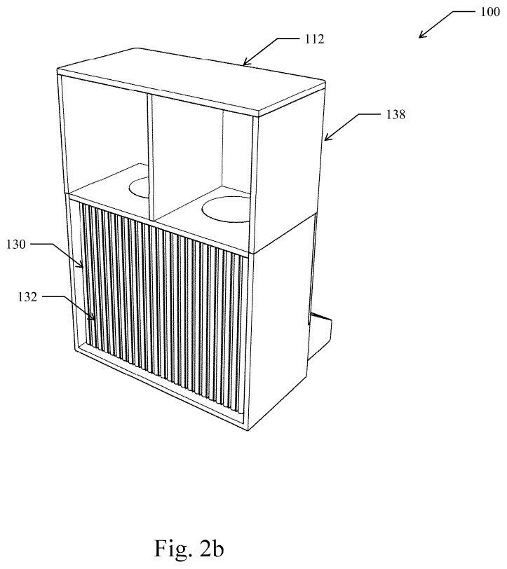

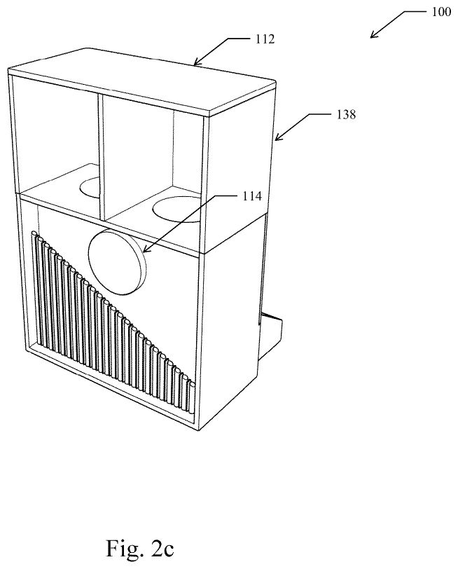

FIGS. 2a-2c show rear perspective views of the apparatus 100, highlighting a thermoelectric cooling system 130. A cooling fan 114 is centrally positioned on a rear panel 116 of the housing 102. The cooling fan 114 circulates air to maintain a consistent temperature within the housing 102 and to dissipate heat from the thermoelectric cooling system 130. Vent slots 118 are included on a lower section 140 of the rear panel 16 to facilitate airflow and prevent overheating. The lower section 140 further includes a power input port 120 for connecting to a power supply. In some embodiments, a battery compartment (not shown) may be included to allow the feeder to operate without direct power, ensuring functionality during power outages.

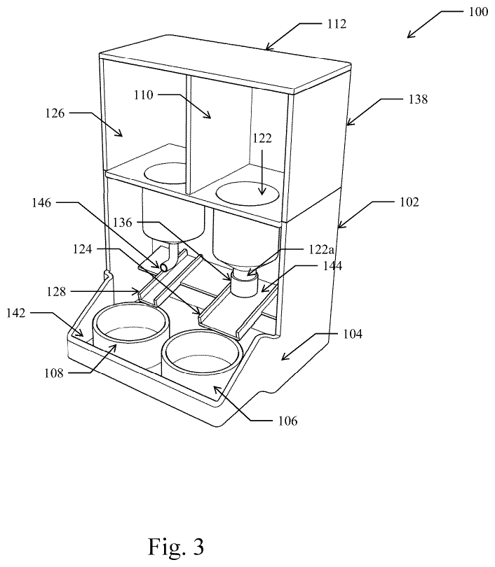

FIG. 3 provides a cross-sectional view of the apparatus 100, illustrating the food and water delivery systems. The food storage compartment 110 houses a bulk food hopper 122. The hopper 122 is shaped to facilitate a smooth, gravity-assisted flow of food. The apparatus 100 utilizes a chute 124 that guides food from the hopper 122 directly to the food bowl 106. This gravity-fed design ensures food is dispensed efficiently and hygienically, minimizing contact with non-food-handling components of the apparatus 100.

A water delivery pathway 128 channels water from the water reservoir 126 to the water bowl 108. The thermoelectric cooling system 130 is positioned to cool both the food storage compartment 110 and the water reservoir 126, ensuring that fresh food is preserved and that dispensed water is cool. The thermoelectric cooling system 130 comprises cooling fins and coils 132 to dissipate heat effectively. Insulating material may surround the food storage compartment 110 and the water reservoir 126 to maintain a low temperature efficiently. The thermoelectric coooling system can be deactivated when dispensing non-refrigerated food.

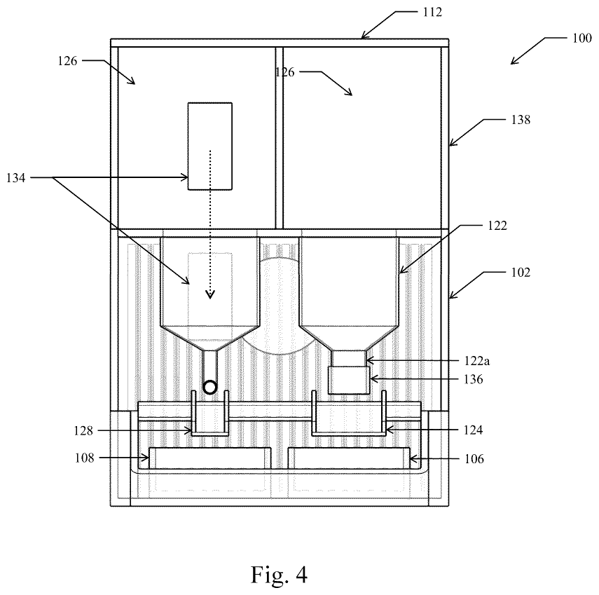

As shown in FIG. 4, the water delivery system 146 includes a water filtration unit 134, which may contain an activated carbon filter, located within the water reservoir 126 or along the water delivery pathway 128. This ensures that water is purified before being dispensed into the water bowl 108. A food dispensing control mechanism 136 is located at a lower side 122a of the hopper 122 and controls the portion of food released through the chute 124. The dispensing of food can be controlled based on preset weight thresholds, monitored by sensors, or by scheduled feeding times programmed by the user.

In models equipped with smart connectivity, a user can control and monitor the apparatus 100 via a mobile application. This allows for remote scheduling of feeding times, adjustment of portion sizes, and monitoring of food and water levels. The application can provide real-time notifications when food or water is low, or when refrigerated food is nearing an expiration date entered by the user. The system may also be integrated with smart home assistants for voice-command operation. For value-priced models, a user can manually program feeding schedules and portion sizes via onboard controls.

To ensure safety and prevent overfeeding, tamper-resistant mechanisms, such as the secure, tamper-resistant door 112, are integrated to prevent pets from accessing the food storage compartment 110 or water reservoir 126. Advanced models may include tamper detection sensors that send an alert to the user's mobile app if unauthorized access is detected. Components that come into direct contact with food and water, such as the food bowl 106, water bowl 108, hopper 122, chute 124, and water reservoir 126, may be constructed from materials like stainless steel or food-grade silicone to enhance durability and hygiene, and are designed to be removable and washable.

1-13. (canceled)

14. An automatic pet feeding and watering apparatus 100 for improved functionality, maintainability and durability, the automatic pet feeding and watering apparatus comprises:
a housing 102 with a base member 104, the base member 104 provides stability to the automatic pet feeding and watering apparatus 100 and includes a recessed tray area 142 that accommodates a food bowl 106 and a water bowl 108;
a food storage compartment 110 disposed within the housing 102, the food storage compartment 110 has a bulk food hopper 122;
a water reservoir 126 disposed within the housing 102 and separate from the food storage compartment 110;
a thermoelectric cooling system 130 configured to cool both the food storage compartment 110 and the water reservoir 126;
a food delivery system 144 that has a chute 124 and a food dispensing control mechanism 136, the chute extends from the bulk food hopper 122 to the food bowl 106, and is configured to facilitate a smooth, gravity-assisted flow of food and to minimize contact between food and non-food-handling components of the automatic pet feeding and watering apparatus 100, the food dispensing control mechanism 136 is located at a lower side 122a of the bulk food hopper 122 and is configured to control the dispensing of food through the chute 124; and
a water delivery system 146 that has water delivery pathway 128 and a water filtration unit 134, the water delivery pathway 128 channels water from the water reservoir 126 to the water bowl 108, the water filtration unit 134 is configured to purify water from the water reservoir 126 before delivery to the water bowl 108.

15. The automatic pet feeding and watering apparatus of claim 14, wherein a smart connectivity module 148 connects the automatic pet feeding and watering apparatus 100 to a mobile application for remote control and monitoring of feeding schedules, portion sizes, and water levels.

16. The automatic pet feeding and watering apparatus of claim 15, wherein the mobile application is configured to receive real-time notifications when food or water levels are low, or when a user-entered food expiration date is approaching.

17. The automatic pet feeding and watering apparatus of claim 14, wherein a secure, tamper-resistant door 112 provides access to the food storage compartment 110 to prevent pets from accessing food outside of scheduled times.

18. The automatic pet feeding and watering apparatus of claim 14, wherein the food storage compartment 110 and the water reservoir 126 are removable and washable.

19. The automatic pet feeding and watering apparatus of claim 14, wherein the thermoelectric cooling system 130 can be deactivated to allow for dispensing of non-refrigerated food.

20. The automatic pet feeding and watering apparatus of claim 14, wherein the food bowl 106, the water bowl 108, the bulk food hopper 122, and the water reservoir 126 are constructed from a stainless steel material or a food-grade silicone material.
